(19) United States
(12) Patent Application Publication
(10) Pub. No.: US 2025/0318554 A1
(43) Pub. Date: Oct. 16, 2025

(54) PRIMARY FRYING METHOD USING COLLABORATIVE ROBOT

(71) Applicants: NEUROMEKA CO., LTD., Seoul (KR); KYOCHON F&B CO., LTD., Chilgok-gun (KR)

(72) Inventors: Tae Jung KIM, Seoul (KR); Young Jin HEO, Seoul (KR); Jong Hoon PARK, Namyangju-si (KR); Mun Seong BANG, Hwaseong-si (KR); Seon Geun KIM, Pyeongtaek-si (KR)

(21) Appl. No.: 18/866,031

(22) PCT Filed: May 16, 2023
(86) PCT No.: PCT/KR2023/006578

§ 371 Date: Nov. 14, 2024

(30) Foreign Application Priority Data
May 17, 2022 (KR) 10-2022-0060271

(51) Int. Cl. A23L 5/10; A47J 37/12; B25J 11/00

(52) U.S. Cl. CPC A23L 5/11; A47J 37/1266; B25J 11/0045

(57) ABSTRACT

(a) a step in which a hand robot portion grips a basket assembly having a pair of doors arranged to rotatably move in the same direction and open both openings, and inputs the basket assembly into a fryer containing oil; (b) a step of dipping a plurality of food materials accommodated in the basket assembly into the oil contained in the fryer, to fry the plurality of food materials with oil; and (c) a step in which, when a direction in which the basket assembly is input into and withdrawn from the fryer is a Z-axis direction and a plane perpendicular to the Z-axis direction is an XY plane, the hand robot portion moves the basket assembly in at least one of an X-axial line direction, a Y-axial line direction, and a Z-axial line direction during step (b), to individually separate the plurality of food materials.

### TECHNICAL FIELD

The present disclosure relates to a primary frying method using a collaborative robot and, in more detail, a primary frying method using a collaborative robot that primarily fries a plurality of food materials with oil using the collaborative robot.

### BACKGROUND ART

A collaborative robot, which is a robot working with humans, unlike industrial robots, generally refers to a robot that is designed and used to interface with humans. In detail, distinguishing between industrial robots and collaborative robots, industrial robots perform tasks on behalf of humans in a work space that is separated from humans and collaborative robots increase work efficiency while working with humans by complementing humans.

Recently, there has been an increase in the usability of robotic technologies for non-face-to-face services along with research and development. In particular, robots perform simple, repetitive, and dangerous tasks and humans are increasingly interested in the use of collaborative robots in the food service industry where they can focus on services. For example, cooking tasks in the food service industry that are simple, repetitive, and dangerous are partially replaced by collaborative robots, while humans perform the role of serving the cooked food to consumers.

Such collaborative robots are used in the food service industry, particularly in the cooking process of frying food materials such as chicken in oil. Collaborative robots replace dangerous, simple, and repetitive tasks due to oil that may be generated during frying processes by humans by putting food materials into a fryer filled with oil and then frying the food materials in the oil.

Meanwhile, the frying process generally involves coating a plurality of food materials with batter, then, dusting them with flour, and finally, immersing them in oil. When humans perform frying, a plurality of food materials may stick to each other due to the viscosity of batter, so there is a need for an additional separation process of individually separating a plurality of food materials using an oil separator.

However, since humans use an oil separator to individually separate a plurality of food materials in a frying process, there is a problem in that not only does the takt time increase, but musculoskeletal disorders are also caused due to simple and repetitive tasks along with an increase in the danger due to spillage of oil.

Accordingly, there is an increasing need for developing an operation process for collaborative robots that enables the collaborative robots to individually separate a plurality of food materials when the collaborative robots perform frying.

### DISCLOSURE

### Technical Problem

An objective of the present disclosure is to provide a primary frying method using an improved collaborative robot that has a work process that can not only prevent a plurality of food materials from sticking to each other, but can also individually separate a plurality of food materials when frying a plurality of food materials using the collaborative robot.

### Technical Solution

The objectives of the present disclosure are achieved by a primary frying method using a collaborative robot. The primary frying method includes: (a) a step in which a hand robot portion holds a basket assembly having a pair of doors disposed to open openings at both sides by rotating in the same direction, and loads the basket assembly into a fryer accommodating oil; (b) a step of frying the plurality of food materials with the oil by immersing the plurality of food materials accommodated in the basket assembly into the oil accommodated in the fryer; and (c) a step in which, when a direction in which the basket assembly is loaded into and unloaded out of the fryer is a Z-axial direction and a plane perpendicular to the Z-axial direction is an XY plane, the hand robot portion individually separates the plurality of food materials by moving the basket assembly in at least any one direction of the X-axial direction, the Y-axial direction, and the Z-axial direction during the step (b).

Meanwhile, the objectives of the present disclosure are achieved also by a primary frying method using a collaborative robot. The primary frying method includes: (a) a step in which the hand robot portion holds a basket assembly and loads the basket assembly into a fryer accommodating oil; (b) a step of frying the plurality of food materials with the oil by immersing the plurality of food materials accommodated in the basket assembly into the oil accommodated in the fryer; and (c) a step in which, when a direction in which the basket assembly is loaded into and unloaded out of the fryer is a Z-axial direction and a plane perpendicular to the Z-axial direction is an XY plane, the hand robot portion individually separates the plurality of food materials by moving the basket assembly in at least any one direction of the X-axial direction, the Y-axial direction, and the Z-axial direction during the step (b).

In this configuration, the hand robot portion may include: a gripper configured to hold the basket assembly; a body having the gripper at an end, having a plurality of multi-joint arms, and configured to move the basket assembly; and a processor configured to create work control instructions for moving the basket assembly in at least any one direction of the X-axial direction, the Y-axial direction, and the Z-axial direction with respect to the gripper and the body.

A tolerance enabling relative rotation between the basket assembly and the gripper when the gripper holds the basket assembly is set, so the gripper may absorb the shock generated between the fryer and the basket assembly.

The step (c) may individually separate the plurality of food materials using collision of an inside of the basket assembly and the plurality of food materials accompanying movement of basket on the basis of operation of the hand robot portion.

In the step (c), when the basket assembly is moved with respect to the XY plane and in the Z-axial direction, the plurality of food materials may collide with inner surfaces and a bottom surface of the basket assembly on the basis of operation of the hand robot portion.

The step (c) may individually separate the plurality of food materials using flow of the oil that is generated when moving the basket assembly with respect to the XY plane and in the Z-axial direction on the basis of operation of the hand robot portion.

Further, the primary frying method using a collaborative robot may further include (d) a step in which, when a front-rear movement direction of the basket assembly is an X-axial direction and a left-right movement direction is a Y-axial direction, the hand robot portion individually separates the plurality of food materials using collision of the basket assembly and the plurality of food materials by rotating around the X-axial direction.

The step (d) may individually separate the plurality of food materials using flow of the oil that is generated by rotation of the basket assembly on the basis of operation of the hand robot portion.

The details of other example embodiments are included in the following detailed description and the accompanying drawings.

### Advantageous Effects

The effects of the primary frying method using a collaborative robot according to the present disclosure are as follows.

First, since the basket assembly is moved using the hand robot portion in the process of primarily frying a plurality of food materials, it is possible to implement collision of the fryer and the basket assembly and collision of the basket assembly and the plurality of food materials, so it is possible to reduce the takt time of the process of primary frying by individually separating a plurality of food materials.

Second, since flow of oil is generated by movement of the basket assembly using the hand robot portion in the process of primarily frying a plurality of food materials, it is possible to individually separate the plurality of food materials, so it is possible to reduce the takt time in primary frying.

### DESCRIPTION OF DRAWINGS

FIG. 1 is a perspective view of a frying device using a collaborative robot according to an embodiment of the present disclosure.

FIG. 2 is a perspective view of the hand robot portion shown in FIG. 1.

FIG. 3 is a first operation perspective view of a basket assembly according to an embodiment of the present disclosure.

FIG. 4 is an enlarged perspective view of the region A shown in FIG. 3.

FIG. 5 is a second operation perspective view of the basket assembly according to an embodiment of the present disclosure.

FIG. 6 is a perspective view of a basket assembly according to another embodiment of the present disclosure.

FIG. 7 is a flowchart of a primary frying method using a collaborative robot according to a first embodiment of the present disclosure.

FIG. 8 is a first operation view of a frying device using a collaborative robot according to the first embodiment of the present disclosure.

FIG. 9 is another first operation view of the frying device using a collaborative robot shown in FIG. 8.

FIG. 10 is a second operation view of the frying device using a collaborative robot according to the first embodiment of the present disclosure.

FIG. 11 is a third operation view of the frying device using a collaborative robot according to the first embodiment of the present disclosure.

FIG. 12 is a fourth operation view of the frying device using a collaborative robot according to the first embodiment of the present disclosure.

FIG. 13 is a flowchart of a primary frying method using a collaborative robot according to a second embodiment of the present disclosure.

FIG. 14 is an operation view of a frying device using a collaborative robot according to the second embodiment of the present disclosure.

### MODE FOR DISCLOSURE

Hereafter, a primary frying method using a collaborative robot according to an embodiment of the present disclosure is described in detail with reference to the accompanying drawings. It should be noted that the primary frying method using a collaborative robot according to embodiments of the present disclosure is performed by a frying device using a collaborative robot.

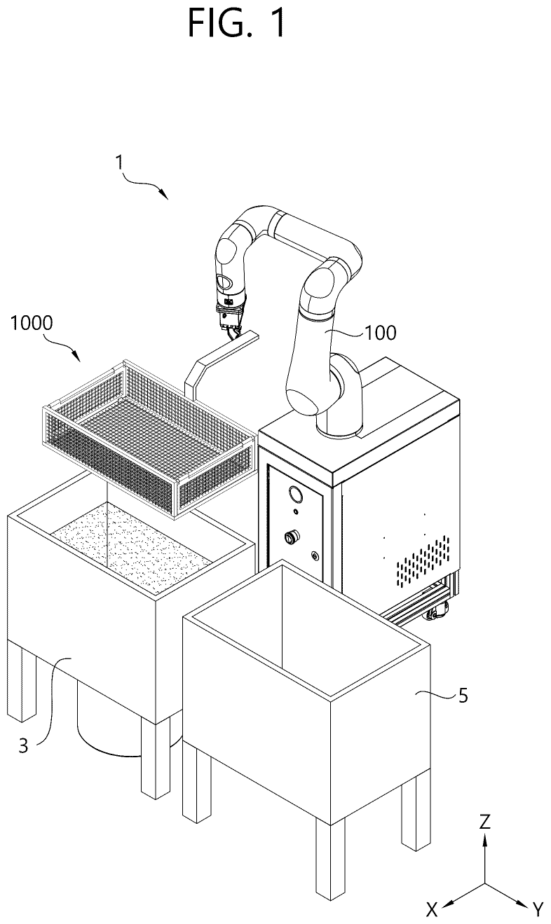

It should be noted that two basket assemblies that are used in the primary frying method using a collaborative robot according to embodiments of the present disclosure are separately shown in FIGS. 1 to 5 and FIG. 6, but the same components are given the same reference numerals. Further, it should be noted that, in the primary frying method using a collaborative robot according to embodiments of the present disclosure, the same components are given the same reference numerals.

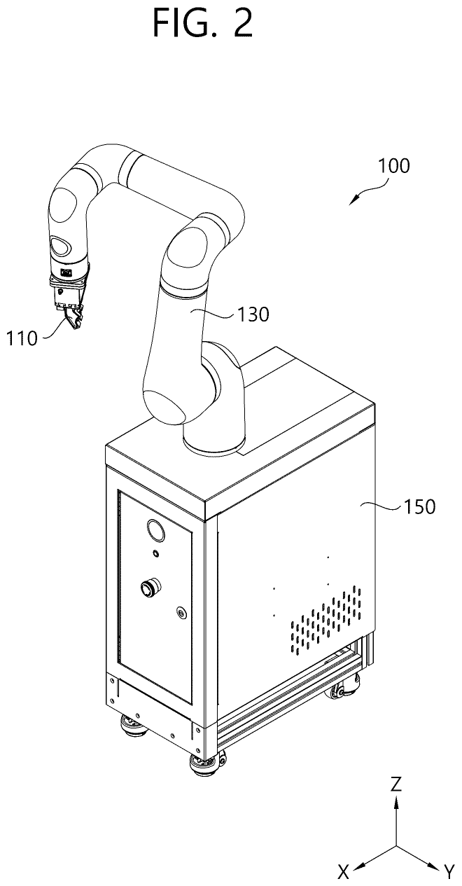

FIG. 1 is a perspective view of a frying device using a collaborative robot according to an embodiment of the present disclosure, and FIG. 2 is a perspective view of the hand robot portion shown in FIG. 1.

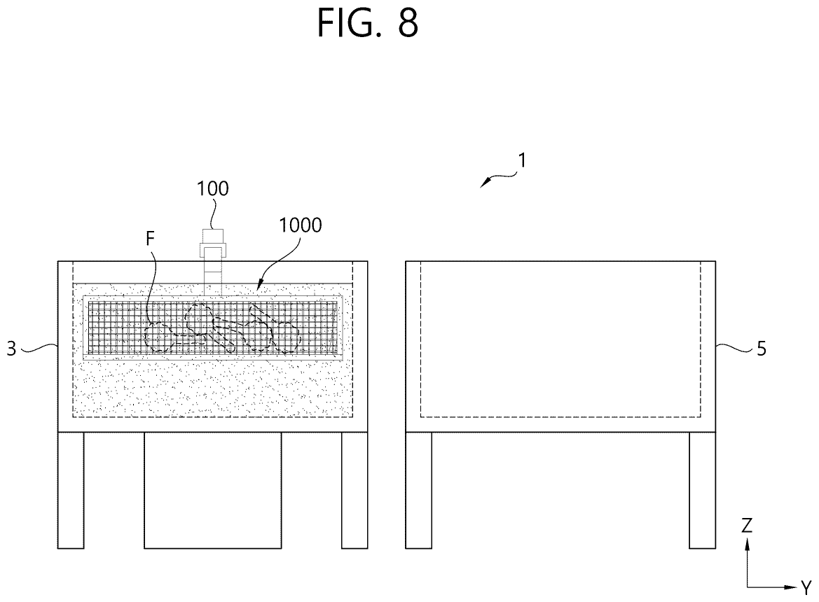

A frying device using a collaborative robot according to an embodiment of the present disclosure, as shown in FIG. 1 and FIG. 2, includes a hand robot portion 100 and a basket assembly 1000. Further, the frying device 1 using a collaborative robot according to an embodiment of the present disclosure includes a fryer 3 and a fry storage container 5. The frying device 1 using a collaborative robot according to an embodiment of the present disclosure uses a cooking type that fries a plurality of food materials F (see FIGS. 8 to 13) in heated oil. In this case, the frying device 1 using a collaborative robot according to an embodiment of the present disclosure performs a cooking process of frying various food materials F, such as chicken that can be cooked into fried chicken, in heated oil. In detail, the frying device 1 using a collaborative robot according to an embodiment of the present disclosure fries a plurality of food materials F coated with batter and dusted with flour, etc. The frying device 1 using a collaborative robot primarily fries and secondarily fries a plurality of food materials F, but a primary frying method using a collaborative robot according to embodiments of the present disclosure relates to primary frying of a plurality of food materials F and the primary frying method is described hereafter.

The fryer 3 accommodates oil for frying food materials F. The fryer 3 includes a heating unit (not illustrated) for heating to fry a plurality of food materials F. The basket assembly 1000 having a plurality of food materials F therein is immersed into the heated oil in the fryer 3. The fry storage container 5 is disposed to store a plurality of food materials F cooked in the heated oil from the fryer 3. A plurality of food materials cooked and discharged from the basket assembly 1000 is stored in the fry storage container 5. In this configuration, a plurality of primarily fried food materials F and a plurality of secondarily fried food materials F are sequentially stored in the fry storage container 5.

The hand robot portion 100 performs a series of processes of moving the basket assembly 1000 with a plurality of food materials F therein to the fryer 3, loading and unloading the basket assembly 1000 into and out of the fryer 3, moving the basket assembly 1000 out of the fryer 3 to the fry storage container 5, and discharging cooked food materials F from the basket assembly 1000 to the fry storage container 5 by rotating the basket assembly 1000.

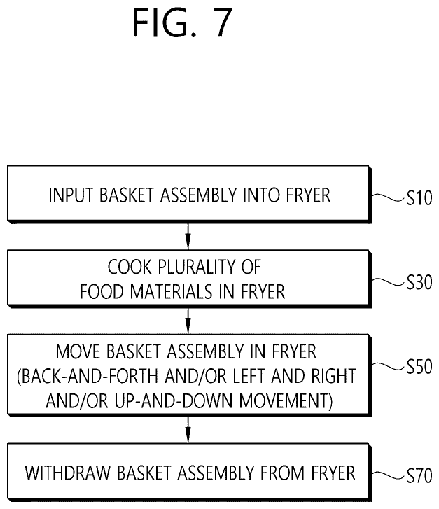

Further, the hand robot portion 100 prevents a plurality of food materials F from sticking to each other during primary frying of the plurality of food materials F and moves the basket assembly 1000 to individually separate the plurality of food materials F. In detail, when the direction in which the basket assembly 1000 is loaded into and unloaded out of the fryer 3 in the drawings is a Z-axial direction and the plane perpendicular to the Z-axial direction is an XY plane, the hand robot portion 100 moves the basket assembly 1000 in at least any one direction of the X-axial direction, the Y-axial direction, and the Z-axial direction to individually separate a plurality of food materials F in the process of frying the plurality of food materials F. Further, the hand robot portion 100 rotates the basket assembly 1000 around the X-axial direction to individually separate a plurality of food materials F. The method in which the hand robot portion 100 individually separates a plurality of food materials F by moving the basket assembly 1000 in the process of primary frying will be described below in detail with reference to FIGS. 7 to 14.

As an embodiment of the present disclosure, the hand robot portion 100 includes a gripper 110, a body 130, and a processor 150. The gripper 110 holds the basket assembly 1000. The gripper 110 is operated to selectively hold a grip 1300 of the basket assembly 1000. A tolerance enabling relative rotation between the basket assembly 1000 and the gripper 110 when the gripper 110 holds the basket assembly 1000 is set, so the gripper 110 absorbs the shock generated between the fryer 3 and the basket assembly 1000. In detail, when a plurality of food materials F is individually separated, a shock is generated between the basket assembly 1000 and the fryer 3 and the generated shock is transmitted to the hand robot portion 100. In this case, in order to prevent the hand robot portion 100 from being stopped by excessive shock, a tolerance enabling relative rotation between the basket assembly 1000 and the gripper 110 when holding the basket assembly 1000 is set, so the shock that is transmitted to the body 130 from the basket assembly 1000 is absorbed.

The gripper 110 is disposed at the end of the body 130 and the body 130 has a plurality of multi-joint arms. The body 130 selectively moves, moves up and down, and rotates the basket assembly 1000 held by the gripper 110. In detail, after the basket assembly 1000 is held by the gripper 110, the body 130 moves the basket assembly 1000 to the fryer 3, loads and unloads the basket assembly 1000 into and out of the fryer 3, moves the basket assembly 1000 to the fry storage container 5, and rotates the basket assembly 1000 to discharge cooked food materials F accommodated in the basket assembly 1000. Further, as in the present disclosure, the body 130 moves the basket assembly 1000 in at least any one direction of the X-axial, Y-axial, and Z-axial directions and rotates the basket assembly 1000 to prevent a plurality of food materials F from sticking and individually separate the plurality of food materials F in the process of primary frying.

The processor 150 creates work control instructions for the gripper 110 and the body 130. The processor 150, as an embodiment of the present disclosure, creates work control instructions for the gripper 110 and the body 130 using a multi-thread. For example, the processor 150 uses a multi-thread including a plurality of threads such as a thread that determines work with the highest priority by determining priorities between a plurality of items of work, a thread that checks the state information of the gripper 110 and the body 130, and a thread that receives instruction information that is generated to a user interface. The processor 150 creates work instructions for performing a series of processes of the frying method using a collaborative robot according to an embodiment of the present disclosure. The processor 150 creates work control instructions to move and rotate the basket assembly 1000 in the process of primarily frying a plurality of food materials F.

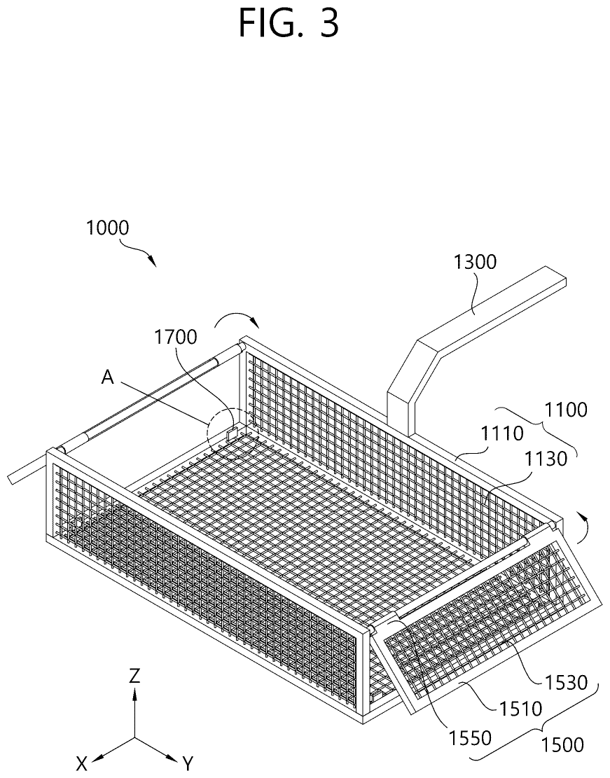

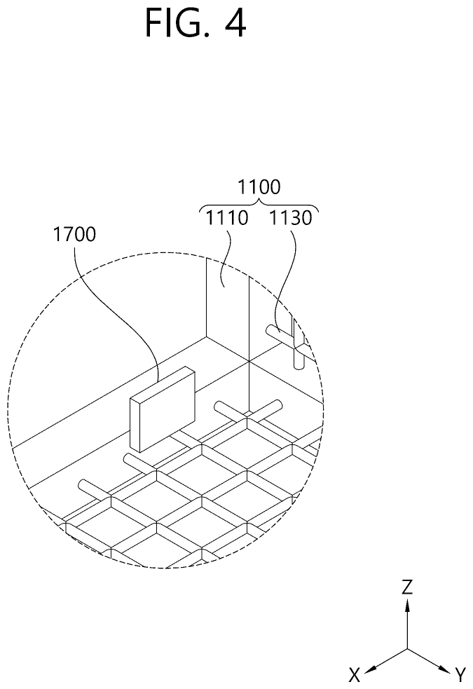

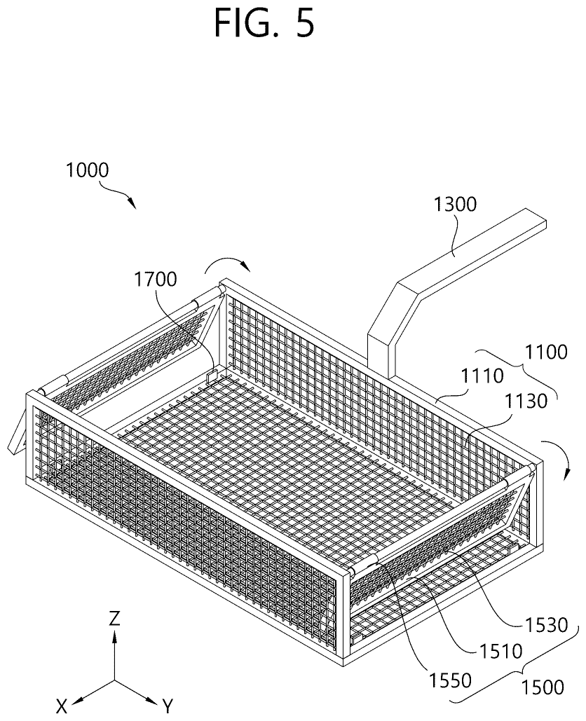

FIG. 3 is a first operation perspective view of a basket assembly according to an embodiment of the present disclosure, FIG. 4 is an enlarged perspective view of the region A shown in FIG. 3, and FIG. 5 is a second operation perspective view of the basket assembly according to an embodiment of the present disclosure.

As shown in FIGS. 3 to 5, the basket assembly according to an embodiment of the present disclosure includes a basket 1100, a grip 1300, doors 1500, and stoppers 1700. In this configuration, the basket assembly 1000 according to an embodiment of the present disclosure is used for primary frying that primarily fries a plurality of food materials F.

The basket 1100 is loaded into and unloaded out of the fryer 3 accommodating oil. The basket 1100 accommodates a plurality of food materials F, is loaded into the fryer 3 to be immersed into the oil accommodated in the fryer 3, and is unloaded out of the fryer 3 after a predetermined time in accordance with the kinds of plurality of food materials F. The basket 1100, as an embodiment of the present disclosure, includes frames 1110 and basket mesh parts 1130.

The frames 1110 are disposed in a hexahedron shape to form an internal space for accommodating a plurality of food materials F. In the hexahedron shape formed by the frames 1110, when the position where the grip 1300 is disposed is a rear surface and the opposite surface is a front surface, both sides are defined as both sides surfaces and the upper and lower portions are defined as top and bottom surfaces. The frames 1110 have a rectangular cross-sectional shape, as an embodiment of the present disclosure, but may have a polygonal cross-section other than a circular cross-section.

The basket mesh parts 1130 are disposed on the front surface, the rear surface, and the bottom surface formed by the frame 1110. The basket mesh parts 1130 are formed in a mesh structure accommodating a plurality of food materials F and passing oil. In this configuration, since the basket mesh parts 1130 are disposed on the front surface, the rear surface, and the bottom surface formed by the frame 1110, the top surface and the both side surfaces formed by the frames 1110 form openings. A plurality of food materials F to be cooked in the fryer 3 is fed through the open top surface formed by the frames 1110. Further, any one of both open side surfaces formed by the frames 1110 is used as a discharge passage for discharging a plurality of cooked food materials F.

The grip 1300 is disposed at the upper portion of the frame 1110 and is held by the gripper 110 of the hand robot portion 100 such that the basket 1100 can be moved, moved up and down, rotated, and moved between the fryer 3 and the fry storage container 5. The grip 1300 is disposed at the upper portion of the frame 1110 forming the rear surface, as described above. The grip 1300 is given a tolerance set for relative rotation between the basket assembly 1000 and the gripper 110 to absorb the shock that is transmitted to the body 130 from the basket assembly 1000.

Since the basket 110 and the grip 1300 are repeatedly loaded into and unloaded out of high-temperature oil heated in the fryer 3, they may be thermally deformed or shocked due to heat transmitted from high-temperature oil. Accordingly, the basket 110 and the grip 1300 are manufactured into a machined structure using a material for preventing thermal deformation or shock.

The doors 1500 are disposed in a pair on both side surface of the basket 1100, respectively. The doors 1500 are formed in a mesh structure that passes oil like the basket mesh parts 1130. In this configuration, the mesh structure formed at the doors 1500 and the mesh structure formed at the basket mesh parts 1300 are coated with Teflon for preventing contamination of oil and deformation. The pair of doors 1500 disposed on both side surfaces of the basket 1100, respectively, is rotated with respect to the upper portion of the frames 1100 forming both side surfaces of the basket 1100. The doors 1500 are each connected to the upper portion of the frame 1110 to each be able to rotate maximally at 360 degrees. The doors 1500, as shown in FIG. 3, are disposed to have opposite rotation directions.

Meanwhile, the doors 1500, as shown in FIG. 4, are disposed to have the same rotation direction. Substantially, in the process of primarily frying a plurality of food materials F, any one of the pair of doors 1500, as shown in FIG. 4, is rotated with a rotation direction going outward from the basket 1100 and the other one is rotated with a rotation direction going toward the inside of the basket 1100. In this configuration, by the stoppers 1700, any one of the pair or doors 1500 that is rotated with a rotation direction going outward from the basket 1100 is prevented from rotating toward the inside of the basket 1100 and the other one of the pair of doors 1500 that is rotated with a rotation direction going toward the inside of the basket 1100 is prevented from rotating outward from the basket 1100. As described above, since the pair of doors 1500 has the same rotation direction and is prevented from rotating in different directions by the stoppers 1700, cooked food materials F are discharged only in one direction.

As an embodiment, the pair of doors 1500 each includes a door frame 1510, a door mesh part 1530, and a hinged portion 1550. The door frame 1510 is disposed along the edge of the side open region of the basket 1100. The door mesh part 1530 is disposed inside the door frame 1510 and has a mesh structure that passes oil. The hinged portion 1550 is disposed at the upper portion of the door frame 1510 and is connected to surround the adjacent frame 1100, thereby enabling the door frame 1510 to be rotated maximally in the range of 360 degrees in any one direction going toward or outward from the inside of the basket 1100.

The stopper 1700 is disposed at each of the lower portions of the frames 1110 forming both sides surface of the basket 1100. The stoppers 1700 prevent selective rotation of the pair of doors 1500 in any one direction going toward or outward from the inside of the basket 1100. For example, the stoppers 1700 prevent the door 1500 disposed on the left side in the figures from rotating inward when the door 1500 is rotated outward from the basket 1100, and prevent the door 1500 disposed on the right side in the figures from rotating outward when the door 1500 is rotated toward the inside of the basket 1100.

In detail, when the door 1500 of the pair of doors 1500 that is rotated only outward by the stopper 1700 is rotated to be opened around a virtual axial line passing through the front surface and the rear surface of the basket 1100, that is, the X-axial direction in which the grip 1300 is disposed in the figures, a plurality of food materials F primarily fried in the basket 1100 is discharged out of the basket 1100 by gravity. Meanwhile, the door 1500 of the pair of doors 1500 that is rotated only inward by the stopper 1700 is rotated inward, thereby enabling a plurality of food materials F to be moved to the discharge passage.

Any one of the pair of doors 1500 and the other one are rotated outward and toward the inside of the basket 1100, respectively, in the above description for the convenience of description, but, on the contrary, it is possible to change the discharge passage for cooked food materials F by disposing the doors to rotate toward the inside of the basket 1100 and outward from the basket 1100.

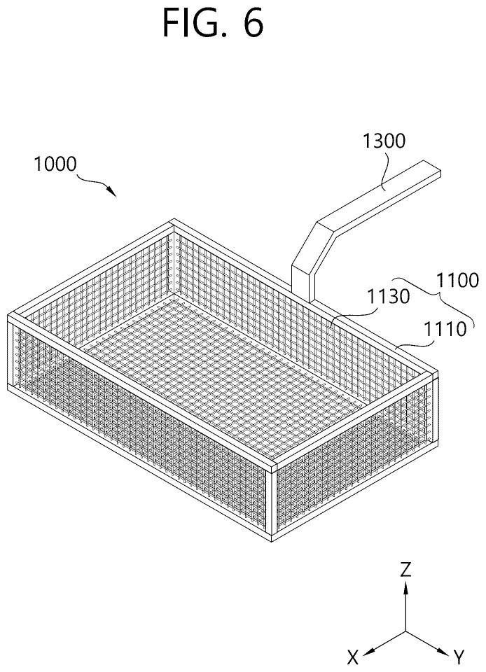

Meanwhile, FIG. 6 is a perspective view of a basket assembly according to another embodiment of the present disclosure.

According to the basket assembly 1000 shown in FIGS. 3 to 5 described above, when a plurality of fried food materials F is discharged to the fry storage container 5, an exit is formed by opening of any one door 1500 of the pair of doors 1500. On the contrary, according to the basket assembly 1000 shown in FIG. 6, a passage for discharging cooked food materials F is formed on top. That is, according to the basket assembly 1000 shown in FIG. 6, the discharge passage is formed only when the rotation angle is large in comparison to the basket assembly 1000 shown FIGS. 3 to 6.

The frames 1110 of the basket assembly shown in FIG. 6 are disposed in a hexahedron shape to form an internal space for accommodating a plurality of food materials F. In the hexahedron shape formed by the frames 1110, when the position where the grip 1300 is disposed is a rear surface and the opposite surface is a front surface, both sides are defined as both sides surfaces and the upper and lower portions are defined as top and bottom surfaces. The frames 1110 have a rectangular cross-sectional shape, as an embodiment of the present disclosure, but may have a polygonal cross-section other than a circular cross-section.

The basket mesh parts 1130 are disposed on the front surface, the rear surface, both side surfaces, and the bottom surface formed by the frames 1110. That is, the basket mesh parts 1130 are disposed on five surfaces except for the top surface of the hexahedron formed by the frames 1110. The basket mesh parts 1130 are formed in a mesh structure accommodating a plurality of food materials F and passing oil.

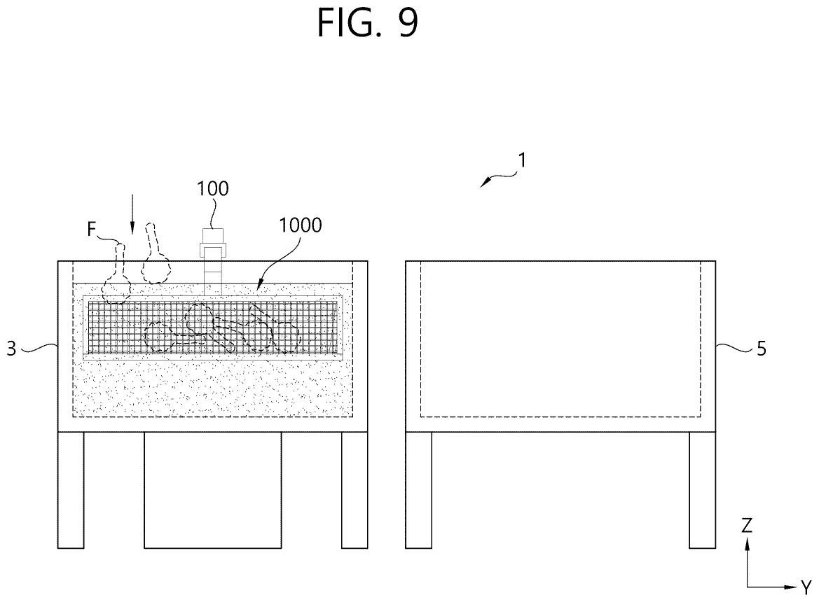

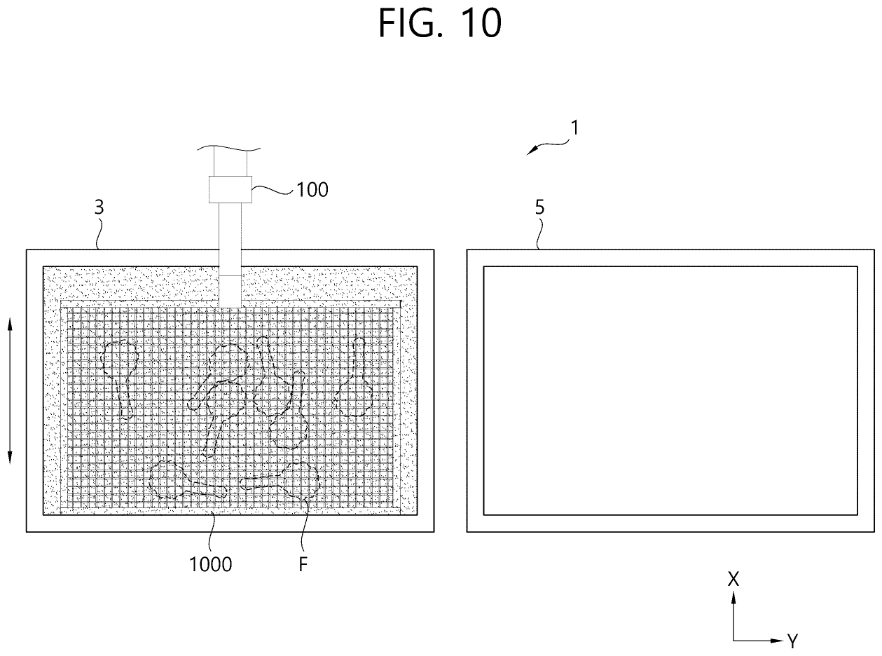

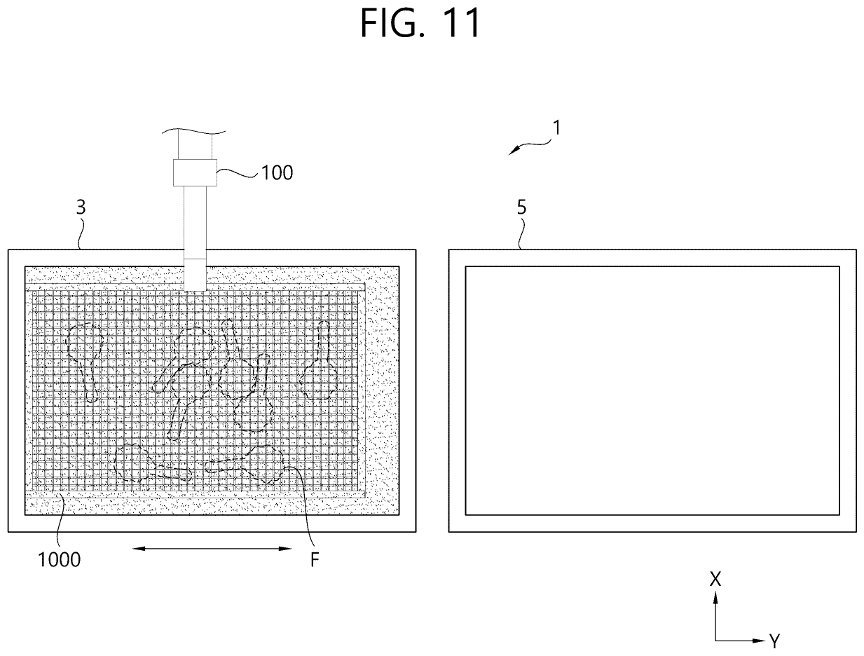

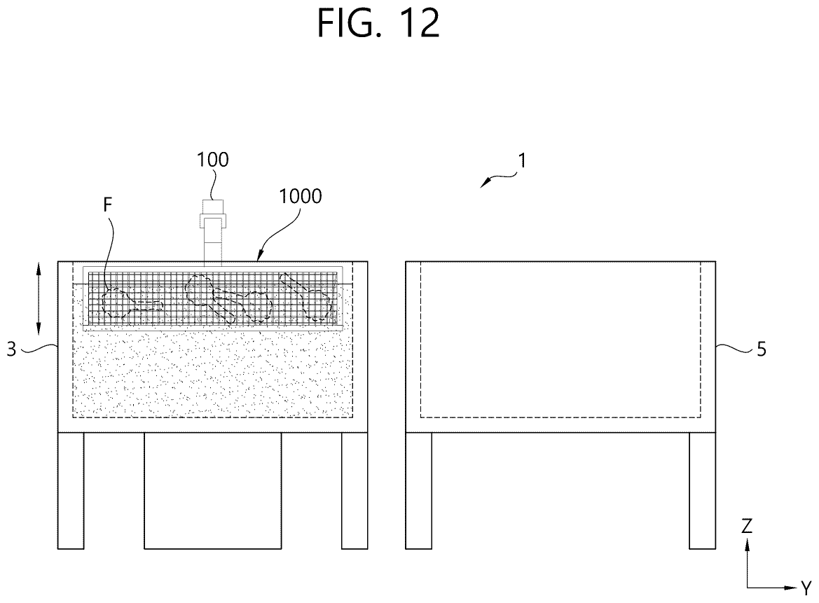

FIG. 7 is a flowchart of a primary frying method using a collaborative robot according to a first embodiment of the present disclosure, FIG. 8 is a first operation view of a frying device using a collaborative robot according to the first embodiment of the present disclosure, FIG. 9 is another first operation view of the frying device using a collaborative robot shown in FIG. 8, FIG. 10 is a second operation view of the frying device using a collaborative robot according to the first embodiment of the present disclosure, FIG. 11 is a third operation view of the frying device using a collaborative robot according to the first embodiment of the present disclosure, and FIG. 12 is a fourth operation view of the frying device using a collaborative robot according to the first embodiment of the present disclosure.

FIG. 7 is a flowchart of a primary frying method using a collaborative robot according to a first embodiment of the present disclosure. When the primary frying method using a collaborative robot according to the first embodiment of the present disclosure shown in FIG. 7 is described, the primary frying method is described in more detail with reference to FIGS. 9 to 12. In this case, it should be noted that the primary frying method using a collaborative robot according to the first embodiment of the present disclosure can use both of the basket assembly 1000 shown in FIGS. 3 to 5 and the basket assembly 1000 shown in FIG. 6.

The hand robot portion 100 holds the basket assembly 1000 and loads the basket assembly 1000 into the fryer 3 accommodating oil (S10). A plurality of food materials F accommodated in the basket assembly 1000 is immersed into the oil accommodated in the fryer 3, thereby frying the plurality of food materials F with the oil (S30). In this case, the steps S10 and S30 are partially different, as shown in FIGS. 8 and 9. In FIG. 8, a plurality of food materials F is accommodated into the basket assembly 1000 in advance and then loaded into the fryer in the step S10, and the plurality of food materials F accommodated in the basket assembly 1000 is fried in the step S30. On the contrary, in FIG. 9, only the basket assembly 1000 is loaded into the fryer 3 and then a plurality of food materials F is put into the basket assembly 1000 in the step S10, and the plurality of food materials F put in the basket assembly 1000 is fried in the step S30.

When the direction in which the basket assembly 1000 is loaded into and unloaded out of the fryer 3 is the Z-axial direction and the plane perpendicular to the Z-axial direction is the XY plane, the hand robot portion 100 individually separates the plurality of food materials F by moving the basket assembly 1000 in at least any one direction of the X-axial, Y-axial, and Z-axial directions during the step S30 (S50). In detail, the step S50 individually separates the plurality of food materials F by moving basket assembly 1000 in the X-axial direction (front-rear direction), as shown in FIG. 10, by moving basket assembly 1000 in the Y-axial direction (left-right direction), as shown in FIG. 11, and by moving basket assembly 1000 in the Z-axial direction (up-down direction), as shown in FIG. 12. In more detail, performing only any one, only any two, or all of movement of the basket assembly 1000 shown in FIG. 10, movement of the basket assembly 1000 shown in FIG. 11, and movement of the basket assembly 1000 shown in FIG. 12 is determined in accordance with work instructions created by the processor 150. The step S50 individually separates the plurality of food materials F using collision with the fryer 3 and collision of the inner surfaces of the basket assembly and the plurality of food materials F when moving the basket assembly 1000. Further, the step S50 individually separates the plurality of food materials F using flow of the oil accompanying movement of the basket assembly 1000 when moving the basket assembly 1000.

After the step S50 is finished, the basket assembly 1000 is unloaded out of the fryer 3 (S70). The step S70 includes also a process of unloading the basket assembly 1000 out of the fryer 3 and discharging the plurality of primarily fried food materials F into the fry storage container 5.

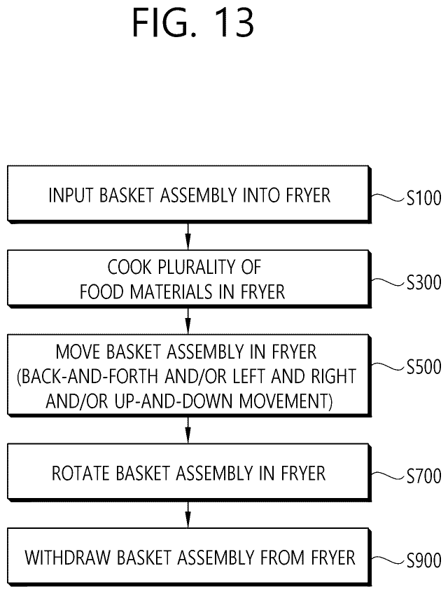

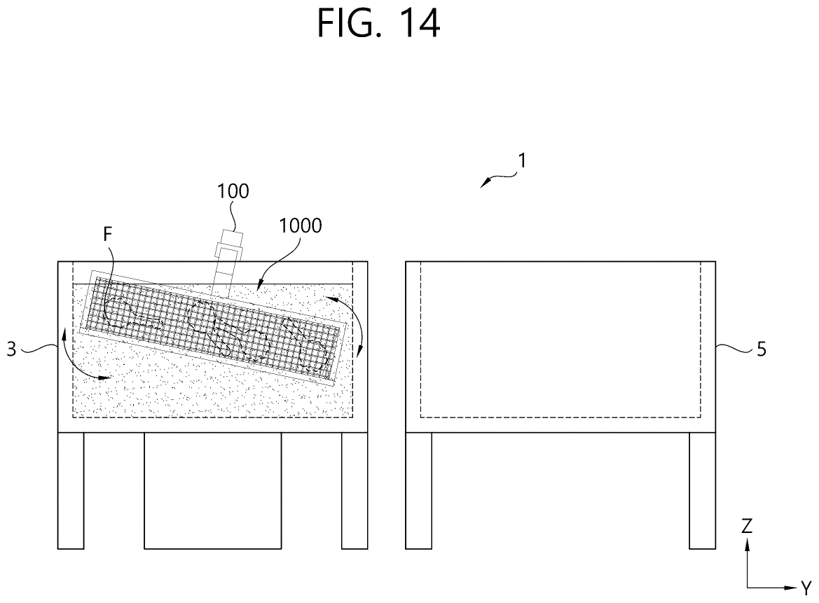

Meanwhile, FIG. 13 is a flowchart of a primary frying method using a collaborative robot according to a second embodiment of the present disclosure and FIG. 14 is an operation view of a frying device using a collaborative robot according to the second embodiment of the present disclosure.

FIG. 13 is a flowchart of a primary frying method using a collaborative robot according to the second embodiment of the present disclosure. When the primary frying method using a collaborative robot according to the second embodiment of the present disclosure shown in FIG. 13 is described, the primary frying method is described in more detail with reference to FIG. 14. In this case, the primary frying method using a collaborative robot according to the second embodiment of the present disclosure also uses the primary frying method using a collaborative robot according to the first embodiment of the present disclosure, so only the technical features that are different from the primary frying method using a collaborative robot according to the first embodiment of the present disclosure are described hereafter.

The hand robot portion 100 holds the basket assembly 1000 and loads the basket assembly 1000 into the fryer accommodating oil (S100). A plurality of food materials F accommodated in the basket assembly 1000 is immersed into the oil accommodated in the fryer 3, thereby frying the plurality of food materials F with the oil (S300). In this case, the steps S100 and S300 use also the method shown in FIGS. 8 and 9 in relation to the primary frying method using a collaborative robot according to the first embodiment of the present disclosure.

When the direction in which the basket assembly 1000 is loaded into and unloaded out of the fryer 3 is the Z-axial direction and the plane perpendicular to the Z-axial direction is the XY plane, the hand robot portion 100 individually separates the plurality of food materials F by moving the basket assembly 1000 in at least any one direction of the X-axial, Y-axial, and Z-axial directions during the step S300 (S500). The step S500 is the same as the step S50 of the primary frying method using a collaborative robot according to the first embodiment of the present disclosure described above.

The hand robot portion 100, as shown in FIG. 14, rotates the basket assembly 1000 around the X-axial line (S700). In detail, the step S700 rotates the basket assembly 1000 around the X-axial direction in the figures. The step S700 individually separates the plurality of food materials F using collision of the basket assembly 1000 and the plurality of food materials F by rotating the hand robot portion around the X-axial direction and individually separates the plurality of food materials F using flow of the oil accompanying rotation of the basket assembly 1000.

After the step S700 is finished, the basket assembly 1000 is unloaded out of the fryer 3 (S900). The step S900 includes also a process of unloading the basket assembly 1000 out of the fryer 3 and discharging the plurality of primarily fried food materials F into the fry storage container 5.

Accordingly, since the basket assembly is moved using the hand robot portion in the process of primarily frying a plurality of food materials, it is possible to implement collision of the fryer and the basket assembly and collision of the basket assembly and the plurality of food materials, so it is possible to reduce the takt time of the process of primary frying by individually separating a plurality of food materials.

Further, since flow of oil is generated by movement of the basket assembly using the hand robot portion in the process of primarily frying a plurality of food materials, it is possible to individually separate the plurality of food materials, so it is possible to reduce the takt time in primary frying.

Although exemplary embodiments of the present disclosure were described above with reference to the accompanying drawings, those skilled in the art would understand that the present disclosure may be implemented in various ways without changing the necessary features or the spirit of the prevent disclosure. Therefore, the embodiments described above are only examples and should not be construed as being limiting in all respects. The scope of the present disclosure is defined by the following claims rather than the above detailed description, and all of changes and modifications obtained from the meaning and range of claims and equivalent concepts should be construed as being included in the scope of the present disclosure.

1. A primary frying method using a collaborative robot, the primary frying method comprising:
(a) a step in which a hand robot portion holds a basket assembly having a pair of doors disposed to open openings at both sides by rotating in the same direction, and loads the basket assembly into a fryer accommodating oil;
(b) a step of frying the plurality of food materials with the oil by immersing the plurality of food materials accommodated in the basket assembly into the oil accommodated in the fryer; and
(c) a step in which, when a direction in which the basket assembly is loaded into and unloaded out of the fryer is a Z-axial direction and a plane perpendicular to the Z-axial direction is an XY plane, the hand robot portion individually separates the plurality of food materials by moving the basket assembly in at least any one direction of the X-axial direction, the Y-axial direction, and the Z-axial direction during the step (b).

2. A primary frying method using a collaborative robot, the primary frying method comprising:
(a) a step in which the hand robot portion holds a basket assembly and loads the basket assembly into a fryer accommodating oil;
(b) a step of frying the plurality of food materials with the oil by immersing the plurality of food materials accommodated in the basket assembly into the oil accommodated in the fryer; and
(c) a step in which, when a direction in which the basket assembly is loaded into and unloaded out of the fryer is a Z-axial direction and a plane perpendicular to the Z-axial direction is an XY plane, the hand robot portion individually separates the plurality of food materials by moving the basket assembly in at least any one direction of the X-axial direction, the Y-axial direction, and the Z-axial direction during the step (b).

3. The primary frying method of claim 1, wherein the hand robot portion comprises:
a gripper configured to hold the basket assembly;
a body having the gripper at an end, having a plurality of multi-joint arms, and configured to move the basket assembly; and
a processor configured to create work control instructions for moving the basket assembly in at least any one direction of the X-axial direction, the Y-axial direction, and the Z-axial direction with respect to the gripper and the body.

4-9. (canceled)

10. The primary frying method of claim 2, wherein the hand robot portion comprises:
a gripper configured to hold the basket assembly;
a body having the gripper at an end, having a plurality of multi-joint arms, and configured to move the basket assembly; and
a processor configured to create work control instructions for moving the basket assembly in at least any one direction of the X-axial direction, the Y-axial direction, and the Z-axial direction with respect to the gripper and the body.

11. The primary frying method of claim 3, wherein a tolerance enabling relative rotation between the basket assembly and the gripper when the gripper holds the basket assembly is set, so the gripper absorbs the shock generated between the fryer and the basket assembly.

12. The primary frying method of claim 10, wherein a tolerance enabling relative rotation between the basket assembly and the gripper when the gripper holds the basket assembly is set, so the gripper absorbs the shock generated between the fryer and the basket assembly.

13. The primary frying method of claim 3, wherein the step (c) individually separates the plurality of food materials using collision of an inside of the basket assembly and the plurality of food materials accompanying movement of basket on the basis of operation of the hand robot portion.

14. The primary frying method of claim 10, wherein the step (c) individually separates the plurality of food materials using collision of an inside of the basket assembly and the plurality of food materials accompanying movement of basket on the basis of operation of the hand robot portion.

15. The primary frying method of claim 13, wherein, in the step (c), when the basket assembly is moved with respect to the XY plane and in the Z-axial direction, the plurality of food materials collides with inner surfaces and a bottom surface of the basket assembly on the basis of operation of the hand robot portion.

16. The primary frying method of claim 14, wherein, in the step (c), when the basket assembly is moved with respect to the XY plane and in the Z-axial direction, the plurality of food materials collides with inner surfaces and a bottom surface of the basket assembly on the basis of operation of the hand robot portion.

17. The primary frying method of claim 13, wherein the step (c) individually separates the plurality of food materials using flow of the oil that is generated when moving the basket assembly with respect to the XY plane and in the Z-axial direction on the basis of operation of the hand robot portion.

18. The primary frying method of claim 14, wherein the step (c) individually separates the plurality of food materials using flow of the oil that is generated when moving the basket assembly with respect to the XY plane and in the Z-axial direction on the basis of operation of the hand robot portion.

19. The primary frying method of claim 3, further comprising (d) a step in which, when a front-rear movement direction of the basket assembly is an X-axial direction and a left-right movement direction is a Y-axial direction, the hand robot portion individually separates the plurality of food materials using collision of the basket assembly and the plurality of food materials by rotating around the X-axial direction.

20. The primary frying method of claim 10, further comprising (d) a step in which, when a front-rear movement direction of the basket assembly is an X-axial direction and a left-right movement direction is a Y-axial direction, the hand robot portion individually separates the plurality of food materials using collision of the basket assembly and the plurality of food materials by rotating around the X-axial direction.

21. The primary frying method of claim 19, wherein the step (d) individually separates the plurality of food materials using flow of the oil that is generated by rotation of the basket assembly on the basis of operation of the hand robot portion.

22. The primary frying method of claim 20, wherein the step (d) individually separates the plurality of food materials using flow of the oil that is generated by rotation of the basket assembly on the basis of operation of the hand robot portion.
